(19) United States
(12) Patent Application Publication
(10) Pub. No.: US 2024/0035849 A1
(43) Pub. Date: Feb. 1, 2024

(54) Method and system for dynamically reducing the complexity of a 3D map

(71) Applicant: Continental Autonomous Mobility Germany GmbH, Ingolstadt (DE)

(72) Inventors: Johannes Eck, Frankfurt am Main (DE); Stefan Luthardt, Darmstadt (DE); Annemarie Albrecht, Lohmar (DE); Chantal Ferdinand, Oberneisen (DE)

(73) Assignee: Continental Autonomous Mobility Germany GmbH, Ingolstadt (DE)

(21) Appl. No.: 18/361,355

(22) Filed: Jul. 28, 2023

(30) Foreign Application Priority Data
Jul. 28, 2022 (DE) 10 2022 207 771.7

(51) Int. Cl. G01C 21/00; G01C 21/34; G01C 21/32

(52) U.S. Cl. CPC G01C 21/3867; G01C 21/3833; G01C 21/3446; G01C 21/32

(57) ABSTRACT

A method for dynamically reducing the complexity of a 3D map in an ego vehicle including recording an environment of the ego vehicle; providing a 3D map; localizing the ego vehicle in the 3D map; and reducing the 3D map by removing roads that overlap each other on different levels of elevation.

### CROSS-REFERENCE TO RELATED APPLICATIONS

The present application claims priority from German Patent Application No. 10 2022 207 771.7 filed on Jul. 28, 2022, in the German Patent and Trade Mark Office, the content of which is herein incorporated by reference.

### BACKGROUND

### 1. Field

Embodiments of the present application relate to a method and system for dynamically reducing the complexity of a 3D map.

### 2. Description of Related Art

Many autonomous driving systems are not configured to function in an environment with a plurality of elevation planes, such as in a multi-story parking garage or at highway junctions. There are concepts in which a plurality of planes is provided, however the navigable transitions between the planes are often not taken into account.

A common solution involves performing a strict change of the map and the entire environment model from one plane to the next. This can cause problems due to a lack of consistency in the environment model. Furthermore, there are surroundings which do not provide the option of clearly defining different stories. For example, there are multi-story parking garages which consist only of ramps.

Another solution involves directly passing on the multi-layer 3D map; all subsequent AD components must process this complex 3D map and plan and carry out actions using this complex 3D map with vertically overlapping roads. This would increase the complexity in all subsequent AD components significantly, which would, for example, increase the technical and calculatory effort needed.

Furthermore, in the document KR 101051310 B1, a method for displaying a road is disclosed in which those roads from a multi-layer 3D map are selected and displayed which are to be used for navigation.

### SUMMARY

Aspects and objects of embodiments of the present application provide a method and a system for simplifying the complexity of 3D maps.

Due to the high complexity of the 3D maps, it was initially thought that the downstream systems for assisted and/or autonomous driving required very high computing power in order to process the amount of data. Further, due to the different layers with different elevations, erroneous driving maneuvers may occur when roads or certain objects or features are categorized as relevant even though they are not relevant for the elevation level being navigated by the ego vehicle.

Accordingly, a method is proposed according to the embodiment for dynamically reducing the complexity of a 3D map in an ego vehicle which comprises the following steps: capturing the environment of the ego vehicle by means of at least one environment detection sensor; providing a 3D map with different elevation levels; localizing the ego vehicle in the 3D map; generating a reduced 3D map by reducing the generated 3D map by means of a reduction algorithm, wherein the reduced 3D map preferably contains roads which are currently relevant for the ego vehicle or for other traffic participants who are relevant for the ego vehicle.

The environment detection sensor can, for example, be a camera or a radar, lidar or ultrasound sensor. It would also be plausible to use several identical and/or different sensors for recording the environment.

The 3D map can, for example, be provided via a database. In this database, the 3D map is stored with the corresponding elevation information and can be accessed by the vehicle. It would also be plausible to fuse the 3D map from map information and sensor data of the at least one environment detection sensor. To this end, an environment representation can be generated and analyzed from the sensor data of the environment detection sensor.

Depending on which environment detection sensor is being used, a different environment representation is generated. If a camera, being either a mono or a stereo camera, is used, the environment representation is an image of the environment or a sequence of images. With a radar sensor, the environment representation is, for example, a list of objects.

In the map data, there is, for example, information about the elevation profile of the environment as well as the course and number of roads. This map data can, for example, be present in a vehicle-internal or vehicle-external database and can be provided via this database. Use of navigation system data would also be conceivable. If the database is configured to be vehicle-external, the data is transmitted by means of a vehicle-to-X communication device, the vehicle in this case having a corresponding V2X communication device.

In the sense of the embodiment, dynamically reducing means that the relevant roads or road portions continually change as the vehicle moves. Accordingly, the relevance of the roads or road portions in the 3D map is checked with each detection cycle and/or each localization cycle of the ego vehicle and the 3D map is, for example, adapted to the changed position of the ego vehicle and the 3D map is thus dynamically reduced.

The reduction algorithm selects the 3D map with potentially overlapping roads with different elevation information and outputs a reduced road map which contains no roads which intersect due to differing elevation information. In order to ensure a minimal forecast or a minimal hindsight, the reduced map is constructed road by road, starting with the current road of the ego vehicle and expanding in all directions until end points are reached. Such an endpoint is reached when no roads or road portions can be added anymore, either because the original 3D map has ended or because one or one further road cannot be added, because one or several lanes would cause an overlap with different elevation information. An endpoint is also reached when all continuing roads have already been added to the reduced road model. The algorithm assigns different priorities to the road in order to control the expansion such that more relevant roads are favored.

Particularly preferably, the reduction of the 3D map is carried out such that it contains no roads or road portions which overlap each other on different elevations.

In a preferred configuration, the reduction algorithm is a graph search algorithm. Particularly preferably, the graph reduction algorithm may be a Dijkstra's algorithm or a breadth-first search. The Dijkstra algorithm generally always follows the edge in a graph with the highest priority relative to the current starting node. In breadth-first search, BFS, starting from the starting point, all nodes are traversed which are directly reachable from the starting point via edges. Afterwards, from these nodes, further nodes are traversed which are directly reachable from those nodes.

In a further preferred embodiment, the relevance of the roads is determined based on their proximity to the ego vehicle, the detection range of the ego vehicle, the level relative to the ego vehicle, and/or the navigability of the roads. In general, the relevance of the roads or road portions decreases the further they are from the ego vehicle, relative to the driving distance. Closer roads which are directly on the same level around the ego vehicle have a higher relevance and, accordingly, a higher priority to be added to the reduced map. Furthermore, roads which are marked as navigable and/or which are on a planned route have a higher relevance. These can, for example, be roads or driving lanes or road portions which have a traffic orientation in the driving direction of the ego vehicle.

Furthermore, roads present in the 3D map are preferably divided into road portions. The division into road portions is advantageous because it allows for better reactions to changes in the roads lying ahead as well as for a more precise reduction of the 3D map.

Particularly preferably, the road portions are divided up based on their respective levels and/or course. If the road ahead has, for example, an inclined course, the road can be divided into one road portion up to that point and another road portion starting from the incline. Furthermore, portions can be introduced, for example, at intersections or forks in the road.

According to the embodiment, further provision is made for a system for reducing a complexity of a 3D map in an ego vehicle, comprising at least one environment detection sensor for recording the environment of the ego vehicle, an analysis unit for analyzing the recording of the environment detection sensor, a device for providing a 3D map, and a computing unit for localizing the ego vehicle and for applying a reduction algorithm to generate a reduced 3D map. The analysis unit can be configured as a separate element or as a component of the environment detection sensor. The computing unit is preferably an electronic control unit or an autonomous driving control unit. The unit for providing the 3D map can, for example, be a vehicle-internal or a vehicle-external database.

Alternatively, the unit can be configured to fuse an environment representation of the sensor data of the environment detection sensor with accessed map data or map data provided via a database. In this case, the unit can be configured as a separate computing unit. It would also be conceivable to carry out the fusion in the already provided computing unit or the ADCU.

### BRIEF DESCRIPTION OF THE DRAWINGS

Further advantageous configurations can be seen in the drawings, in which:

FIG. 1: shows a schematic representation of a flowchart of a method according to an embodiment;

FIG. 2: shows a schematic representation of a system according to an embodiment;

FIG. 3: shows a schematic representation of a 3D map;

FIG. 4: shows a schematic representation of a 3D map;

FIG. 5: shows a schematic representation of a 3D map according to an embodiment;

FIG. 6: shows a schematic representation of a 3D map according to an embodiment; and

FIG. 7: shows a schematic representation of a 3D map according to an embodiment.

### DETAILED DESCRIPTION

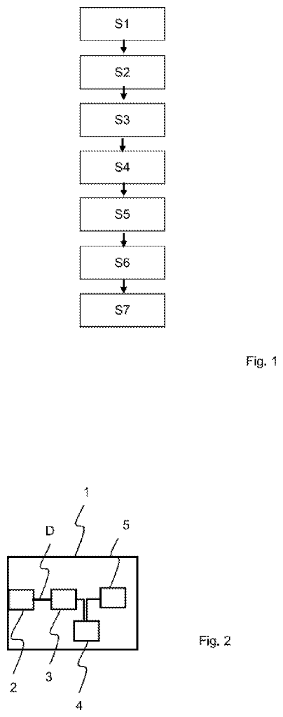

FIG. 1 shows a schematic representation of a flowchart of a method according to an embodiment. In a step S1, an environment of the ego vehicle is recorded by means of at least one environment detection sensor. In a further step S2, a 3D map with elevation information is provided. Subsequently, the ego vehicle E is localized in the 3D map in a step S3. In step S4, a reduced 3D map is generated by reducing the provided 3D map by means of a reduction algorithm, wherein the reduced 3D map preferably contains roads which are currently relevant for the ego vehicle or for further traffic participants, wherein these traffic participants are in turn relevant for the ego vehicle.

FIG. 2 shows a schematic representation of a system according to an embodiment. The system 1 for reducing a complexity of a 3D map in an ego vehicle E comprises at least one environment detection sensor 2 for recording the environment of the ego vehicle E, an analysis unit 3 for analyzing the recording of the environment detection sensor 2, a device 5 for providing a 3D map, and a computing unit for localizing the ego vehicle E and for applying a reduction algorithm to generate a reduced 3D map. The elements are in this case connected to each other via a data connection D. This data connection D can be configured to be wire-based or wireless. The database 5 can in this case be either vehicle-internally or vehicle-externally arranged. The analysis unit 3 can be configured as a separate element or as a component of the environment detection sensor 2. The computing unit 4 is preferably an ECU or an ADCU. In this preferred configuration the system has, as a device 5, a database for providing the 3D map. It would also be plausible to generate the 3D map by means of a fusion of sensor data and map data.

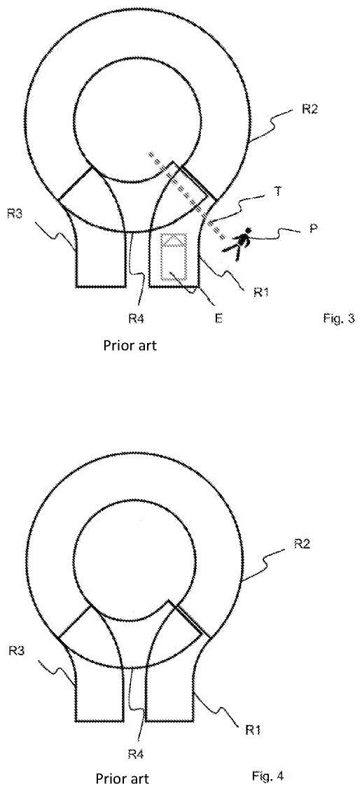

FIG. 3 shows a schematic representation of a 3D map. In this representation, the road of the 3D map is divided into different road portions R1-R4. Furthermore, a pedestrian P was detected in this representation and inserted into the 3D map. Furthermore, a trajectory T of the pedestrian P was predicted. The road portions R1 and R4 are in this case located on different levels. Based on this representation and the current state of the art, a system could assume that the pedestrian P is located on a higher level than the ego vehicle E, because in the bird's eye view of the 3D map the pedestrian also crosses the road portion R4, which is higher than R1, where the ego vehicle was localized, even if the pedestrians are normally detected on the same level as the ego vehicle E. Thus, this could lead to a misinterpretation and therefore to an AD system reacting incorrectly or not at all.

FIG. 4 shows a schematic representation of a 3D map. This representation corresponds to the representation in FIG. 3. In this case, R2 is a ramp which leads from the level of the road portion R1 to the higher up level of the road portions R3 and R4. This would be the representation of the 3D map which would be passed on to downstream AD or ADAS systems according to the prior art.

FIG. 5 shows a schematic representation of a 3D map according to an embodiment. In this representation, the ego vehicle E is on the road portion R1. Due to the reduction of the 3D map, only the road portions R1, R2, and R3 are contained in the 3D map at this point in time. The road portion R4 was removed from the 3D map by the reduction, because in this case R4 crosses R1 but on a higher level. Accordingly, R4 is not relevant for the ego vehicle E in this situation.

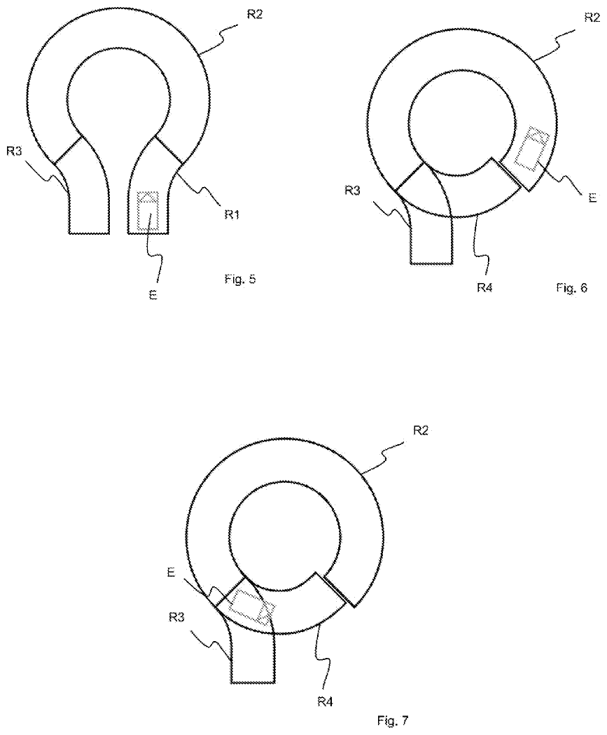

FIG. 6 also shows a schematic representation of a 3D map according to an embodiment. In this representation, the ego vehicle E has moved from the road portion R1 to the road portion R2. In the reduced 3D map, R1 is now no longer outputted, because R1 is not relevant for the vehicle. As is clear in FIG. 2 or 3, R1 and R4 would overlap each other on different levels. Instead, R4 is in this case outputted, because R4 and R3 are on the same level and the former is potentially relevant for the further journey of the ego vehicle.

In FIG. 7, once again a schematic representation of a 3D map according to an embodiment is shown. The ego vehicle E is in this case located on the road portions R3 and R4. In the reduced 3D map, R1 is discarded again due to the outputting of R4.

In general, the FIGS. 5-7 describe an aforementioned dynamic reduction of a 3D map, because the ego vehicle E moves further in each of the figures and, accordingly, different road portions R1-R4 are relevant for the vehicle E and the 3D map is correspondingly reduced.

1. A method for dynamically reducing complexity of a 3D map, the method comprising:
recording an environment by means of at least one environment detection sensor, the environment comprising a structure comprising a first level of roadway at a first elevation and a second level of roadway at a second elevation;
providing a 3D map based on the environment, the 3D map comprising a 3D map of the first level of the roadway and the second level of the roadway;
localizing the ego vehicle on the first level of the roadway in the 3D map; and
reducing the 3D map to remove the second level of the roadway that overlaps in elevation with the first level of the roadway.

2. The method according to claim 1, wherein the reducing comprises reducing the 3D map utilizing a graph search algorithm.
